(19) United States
(12) Patent Application Publication
(10) Pub. No.: US 2016/0018711 A1
(43) Pub. Date: Jan. 21, 2016

(54) DISPLAY DEVICE

(71) Applicant: SHENZHEN CHINA STAR OPTOELECTRONICS TECHNOLOGY CO. LTD., Shenzhen (CN)

(72) Inventor: Caiqin CHEN, Shenzhen (CN)

(21) Appl. No.: 14/416,641

(22) PCT Filed: Dec. 11, 2014
(86) PCT No.: PCT/CN2014/093529

§ 371 Date: Jan. 23, 2015

(30) Foreign Application Priority Data
Jul. 21, 2014 (CN) 201410348615.3

(51) Int. Cl. G02F 1/1362; G09G 3/36

(52) U.S. Cl. CPC G02F 1/136286; G09G 3/3648; G09G 3/3688; G09G 2300/0426

(57) ABSTRACT

In the technical field of display, a display device for solving the technical problem of H-block caused by the resistance of the wire on array is provided. The display device comprises a substrate and at least two chip on films for transmitting the gate driving signal. At least two fanouts are formed on the substrate, and each of the chip on films is connected with a corresponding one of the fanouts. Adjacent chip on films are connected with each other through a wire on array. In two adjacent fanouts, the resistance of the former fanout is larger than that of the latter fanout. The present disclosure can be applied to display devices, such as liquid crystal television, liquid crystal display, cell phone, and tablet PC, and the like.

The present application claims benefit of Chinese patent application CN 201410348615.3, entitled “DISPLAY DEVICE” and filed on Jul. 21, 2014, which is incorporated herein by reference.

### TECHNICAL FIELD

The present disclosure relates to the technical field of display, and in particular, to a display device.

### TECHNICAL BACKGROUND

As display technology develops, a liquid crystal display device has become a commonly used panel display device. In the liquid crystal display device, the pixels are controlled by gate lines and data lines that are arranged in a staggered manner with respect to each other on a substrate, so as to display images.

At present, in order to save cost, a gate driver circuit and a data circuit are usually formed on the same printed circuit board (hereinafter referred to as PCB), and then the PCB is connected to a chip on film (hereinafter referred to as COF) for transmitting a gate driving signal through a wire on array (hereinafter referred to as WOA). The liquid crystal display device usually comprises at least two chip on films for transmitting the gate driving signal. Two adjacent chip on films are connected with each other through a WOA also. Each chip on film is connected to a fanout arranged on the substrate, and then to the gate lines through the fanout.

Since the WOA has a certain resistance, the resistance of the gate line connected to the latter COF would be larger than that of the gate line connected to the former COF, rendering the waveforms of the gate driving signals on the two gate lines to be different from each other. In the meantime, at a connected region between the two adjacent chip on films, the difference between the waveform of the gate driving signal on the last gate line connected to the former chip on film and that of the gate driving signal on the first gate line connected to the latter chip on film is particularly significant. In particular, the characteristic curve of a thin film transistor (hereinafter referred to as TFT) would shift after reliability tests of high temperature and high humidity, causing an increased leaked current or an insufficient charge of the TFT. As a result, the difference between the waveforms becomes even more significant, causing linear mura in an area of the liquid crystal display device corresponding to the connected region between the two adjacent COFs, i.e., H-block. Thus, the display effect of the liquid crystal display device is negatively influenced.

### SUMMARY OF THE INVENTION

The objective of the present disclosure is to provide a display device for solving the technical problem of H-block caused by the resistance of a wire on array.

The present disclosure provides a display device, comprising a substrate, and at least two chip on films for transmitting a gate driving signal, wherein at least two fanouts are formed on the substrate, and each of the chip on films is connected with a corresponding one of the fanouts, and two adjacent chip on films are connected with each other through a wire on array,

wherein in two adjacent fanouts, the resistance of a former fanout is larger than that of the latter fanout.

Preferably, the difference of resistance between the two adjacent fanouts equals to the resistance of the wire on array for connecting the two adjacent chip on films corresponding to the two fanouts.

Further, a fanout comprises a plurality of wires, each being connected to a gate line on the substrate, and

the resistance of each of the wires in the same fanout is the same.

Further, in each fanout, the wires each comprise an arcuate subsection and an extending subsection.

Alternatively, in a last fanout, the wires each comprise an arcuate subsection only, and

in the other fanouts, the wires each comprise an arcuate subsection and an extending subsection.

Further, in each fanout, the resistance of each of the arcuate subsections of the wires is the same, and

in two adjacent fanouts, the resistance of the extending subsection in each of the wires in the former fanout is larger than that of the extending subsection in each of the wires in the latter fanout.

Preferably, the difference of resistance between the extending subsections of the wires in the two adjacent fanouts equals to the resistance of the wire on array for connecting the two chip on films corresponding to the two fanouts.

Preferably, the extending subsection can be in a shape of broken lines, curvilinear shape, or wave line.

Further, the display device further comprises a gate driver circuit, to which the first chip on film is connected through a wire on array.

The present disclosure has the following beneficial effects. In the display device according to the present disclosure, in any two adjacent fanouts, the resistance of the former fanout is larger than that of the latter fanout. During the transmission of the gate driving signal, an additional wire on array would be passed through in the latter fanout would than in the former fanout, such that the sum of resistance of the latter fanout and that of the wire on array can be close to, or even the same with the resistance of the former fanout. In this case, the difference between the waveforms of the gate driving signals can be eliminated, thereby the technical problem of H-block caused by the resistance of the wire on array can be solved. Thus the display effect of the display device can be improved.

Other features and advantages of the present disclosure will be further explained in the following description, and are partially become more readily evident therefrom, or be understood through implementing the present disclosure. The objectives and advantages of the present disclosure will be achieved through the structure specifically pointed out in the description, claims, and the accompanying drawings.

### BRIEF DESCRIPTION OF THE ACCOMPANYING DRAWINGS

In order to illustrate the technical solutions of the examples of the present disclosure more clearly, the accompanying drawings needed for describing the examples will be explained briefly. In the drawings:

FIG. 1 schematically shows a display device according to an example of the present disclosure, and

FIG. 2 schematically shows a part of a fanout in FIG. 1.

### DETAILED DESCRIPTION OF THE EMBODIMENTS

The present disclosure will be explained in detail with reference to the embodiments and the accompanying drawings, whereby it can be fully understood about how to solve the technical problem by the technical means according to the present disclosure and achieve the technical effects thereof, and thus the technical solution according to the present disclosure can be implemented. It is important to note that as long as there is no structural conflict, various embodiments as well as the respective technical features mentioned herein may be combined with one another in any manner, and the technical solutions obtained all fall within the scope of the present disclosure.

A display device according to an example of the present disclosure comprises a. substrate, a printed circuit board (PCB), and a plurality of chip on films for transmitting a gate driving signal and a data signal respectively.

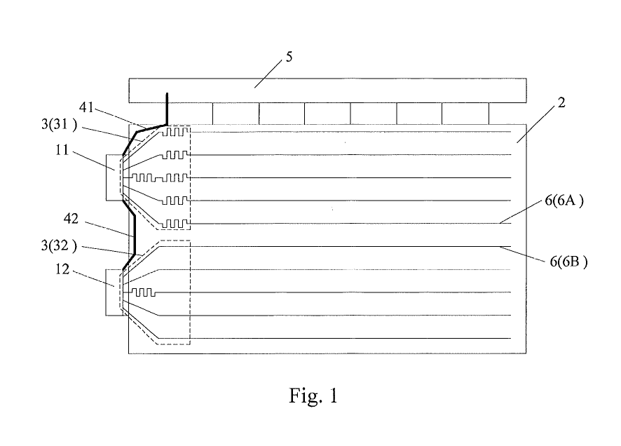

As shown in FIG. 1, in this example, two chip on films 11 and 12 for transmitting the gate driving signal are provided, and two fanouts 31 and 32 are formed on the substrate. In other examples, three chip on films and three fanouts, or more chip on films and more fanouts can be provided.

Each of the chip on films 11 and 12 is connected to a corresponding one of the fanouts 31 and 32. Two adjacent chip on films 11 and 12 are connected with each other through a wire on array 42. In addition, a gate driver circuit (not shown) is arranged in a printed circuit board 5, The first chip on film 11 is connected to the gate driver circuit in the printed circuit board 5 through a wire on array 41.

In the two adjacent fanouts 31 and 32, the resistance of the former fanout 31 is larger than that of the latter fanout 32. In a preferred solution, the difference of resistance between the two fanouts 31 and 32 equals to the resistance of the wire on array 42 for connecting the two chip on films 11 and 12 corresponding to the two fanouts 31 and 32.

In the display device according to an example of the present disclosure, the resistance of the former fanout 31 is larger than that of the latter fanout 32. During the transmission of the gate driving signal, an additional wire on array 42 would be passed through in the latter fallout 32 than in the former fanout 31, such that the sum of resistance of the latter fanout 32 and that of the wire on array 42 can be the same with the resistance of the former fanout 31. In this case, the difference between the waveforms of the gate driving signals can be eliminated, thereby the technical problem of H-block caused by the resistance of the wire on array 42 can be solved. Thus the display effect of the display device can be improved.

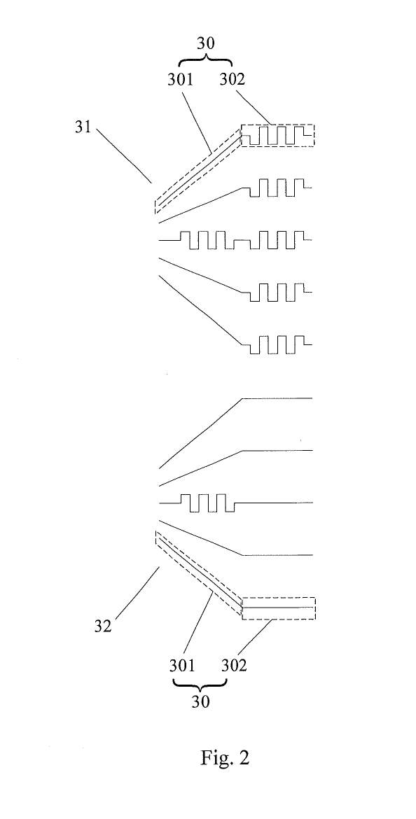

As shown in FIGS. 1 and 2, in the present example, a fanout 3 comprises a plurality of wires 30 each being connected to a gate line 6 on the substrate 2. The resistance of each of the wires 30 in the same fanout 3 is the same, so that the resistance of each of the gate lines 6 connected to the same fanout 3 can be the same, thereby the waveform of the gate driving signal on each of the gate lines 6 can be the same.

In each fanout 3, the wires 30 each comprise an arcuate subsection 301 and an extending subsection 302. In each fallout 3, the resistance of each of the arcuate subsections 301 in the wires 30 is the same. In two adjacent fanouts 31 and 32, the resistance of the extending subsection 302 in each wire 30 of the former fanout 31 is larger than that of the extending subsection 302 in each wire 30 of the latter fanout 32. This is equivalent to a structure consisting of a fanout in the prior art and an additional extending subsection, the latter facilitating the compensation and adjustment of the resistance.

The extending subsection 302 can be made into a shape of broken lines, curvilinear shape, or wave line, so that the length of the extending subsection 302 can be increased within limited space, thereby enabling the resistance of the extending subsection 302 to be large enough. In the last fanout 32, the smaller the resistance of the extending subsection 302 of the wire 30, the better. The resistance of the extending subsection 302 of the wire 30 in the last fanout 32 should be as close to zero as possible. In this case, the extending subsection 302 can be made into a straight line, so as to reduce the resistance thereof.

In other examples, the wires in the last fanout can each comprise an arcuate subsection only, with no extending subsection, so that the arcuate subsections are directly connected to the gate lines. In the other fanouts, the wires each still comprise an arcuate subsection and an extending subsection.

Furthermore, the arcuate subsections 301 of the wires 30 located at both sides of the fanout 3 are arranged to incline for a certain angle, and the nearer a wire 30 is to the center of the fanout 3, the smaller the angle of inclination of the arcuate subsection 301 in the wire 30. The arcuate subsection 301 of the wire 30 located at the center of the fanout 3 can also be made into a shape of broken lines, curvilinear shape, or wave line, so that the length of each of the arcuate subsections 301 can be the same, thereby the arcuate subsections 301 inclining for different angles can have the same resistance.

In a preferred solution, in two adjacent fanouts 31 and 32, the difference of resistance between the extending subsection 302 of each of the wires 30 of the fanout 31 and that of each of the wires 30 of the fallout 32 equals to the resistance of the wire on array 42 for connecting the two chip on films 11 and 12 corresponding to the two fanouts 31 and 32.

In order to illustrate the resistance of the gate line 6 according to an example of the present disclosure more clearly, the resistance of the wire on array 41 can be indicated as R1 and the resistance of the wire on array 42 can be indicated as R2. The resistance of the arcuate subsection 301 of each of the wires 30 in the former fanout 31 and that of the arcuate subsection 301 of each of the wires 30 in the latter fanout 32 are the same, and thus are both indicated as R3. The resistance of the extending subsection 302 of each of the wires 30 in the former fanout 31 is indicated as R2′, which equals to the resistance R2 of the wire on array 42. The resistance of the extending subsection 302 of each of the wires 30 in the latter fanout 32 approaches zero. In this case, a resistance RA of a gate line 6A connected to the last wire 30 of the former fanout 31 is as shown by the equation RA=R1+R3+R2+, and a resistance RB of a gate line 6B connected to the first wire 30 of the latter fanout 32 is as shown by the equation RB=R1+R2+R3. Because R2=R2′, thus RA=RB. That is, the resistance of gate line 6A and that of gate line 6B are the same, thereby the difference between the waveforms of the gate driving signals respectively on gate line 6A and gate line 6B can be eliminated. As a result, the display device according to the present disclosure can solve the technical problem of H-block caused by the resistance of the wire on array 42, and thus improve the display effect thereof.

During the transmission of the gate driving signal through the wire on array 42, in addition to the main interference from the resistance of the wire on array 42 on the gate driving signal, the capacitance of the wire on array 42 would also slightly interfere with the gate driving signal, In this case, the resistance of the extending subsection 302 of each of the wires 30 in the former fanout 31 (or the difference between the resistance of the extending subsection in each of the wires in the former fanout and that of the extending subsection in each of the wires in the latter fanout) can be slightly smaller than the resistance of the wire on array 42, so that the resistance of the extending subsection 302 (or the difference of resistance between the extending subsection in each of the wires in the former fanout and that of the extending subsection in each of the wires in the latter fallout) equals to the sum of the resistance and capacitance of the wire on array 42.

The above embodiments are described only for better understanding, rather than restricting, the present disclosure. Any person skilled in the art can make amendments to the implementing forms or details without departing from the spirit and scope of the present disclosure. The scope of the present disclosure should still be subjected to the scope defined in the claims.

1. A display device, comprising a substrate and at least two chip on films for transmitting a gate driving signal, wherein at least two fanouts are formed on the substrate, and each of the chip on films is connected with a corresponding one of the fanouts, and two adjacent chip on films are connected with each other through a wire on array,
and wherein in two adjacent fanouts, the resistance of a former fanout is larger than that of the latter fanout.

2. The display device according to claim 1, wherein the difference of resistance between the two adjacent fanouts equals to the resistance of the wire on array for connecting the two adjacent chip on films corresponding to the two fanouts.

3. The display device according to claim 1, wherein a fanout comprises a plurality of wires, each being connected to a gate line on the substrate, and
the resistance of each of the wires in the same fanout is the same.

4. The display device according to claim 3, wherein in each fanout, the wires each comprise an arcuate subsection and an extending subsection.

5. The display device according to claim 3, wherein in a last fanout, the wires each comprise an arcuate subsection only, and
in the other fanouts, the wires each comprise an arcuate subsection and an extending subsection.

6. The display device according to claim 4, wherein in each fanout, the resistance of each of the arcuate subsections of the wires is the same, and
in two adjacent fanouts, the resistance of the extending subsection in each of the wires in the former fanout is larger than that of the extending subsection in each of the wires in the latter fanout.

7. The display device according to claim 6, wherein the difference of resistance between the extending subsections of the wires in the two adjacent fanouts equals to the resistance of the wire on array for connecting the two chip on films corresponding to the two fanouts.

8. The display device according to claim 4, wherein the extending subsection can be in a shape of broken lines, curvilinear shape, or wave line.

9. The display device according to claim 1, wherein the display device further comprises a gate driver circuit, to which the first chip on film is connected through a wire on array.
